(19) United States
(12) Patent Application Publication
(10) Pub. No.: US 2010/0016046 A1
(43) Pub. Date: Jan. 21, 2010

(54) FLEXIBLE UNLOADING TUBE

(76) Inventors: Bruce A. Coers, Hillsdale, IL (US); Daniel J. Burke, Cordova, IL (US); Ryan P. Mackin, Milan, IL (US); Shane Anderson, Syracuse, UT (US); David Rix, Sandy, UT (US)

Correspondence Address: Taylor & Aust, P.C/Deere & Company, P.O. Box 560, Avilla, IN, 46710, US

(21) Appl. No.: 12/174,018

(22) Filed: Jul. 16, 2008

(51) Int. Cl. A01F 12/46

(52) U.S. Cl. 460/114

(57) ABSTRACT

An agricultural combine has a flexible unloading tube for discharging the contents of a grain tank positioned on the combine. The unloading tube includes first and second tubes connected by a pair of swivel joints on an intermediate tube. The swivel joints are actuated independent of one another by either electrical or hydraulic power to provide a range of motion significantly greater than found in current combines. A series of augers, connected through flexible joints, move grain material through the unloading tube. The double swivel joints enable the unloader to be conveniently located in the combine with a minimum intrusion on the overall volume of the unit.

### FIELD OF THE INVENTION

The present invention relates to unloading tubes and more specifically to unloading tubes that have an enhanced degree of flexibility.

### BACKGROUND OF THE INVENTION

Unloading tubes are used in many different applications for transferring granular or particulate material from a storage container to another container for transport or further processing. One particular application for unloading tubes is in the field of agricultural harvesters such as combines.

Agricultural harvesters such as combines include a head and a feeder housing which removes the crop material from the field, gathers the material and passes the material to a separator. The separator removes the grain from non-grain crop material. The grain is subsequently cleaned and deposited in a grain tank. When the grain tank becomes full, an unloading tube, which is positioned along side the combine during harvesting, is moved to an unloading position in which the tube extends outward relative to the longitudinal axis of the combine. In this position, the combine drives along side of vehicle into which the grain is to be unloaded such as a semi-trailer and the unloading auger is activated to discharge the grain into the vehicle.

A trend in agricultural machines is for the size of agricultural machines to become larger in order to benefit from the economies of scale. One example is the width of the head on a combine. Since the combine drives along side the vehicle into which the grain is to be unloaded the larger head means that the body of the combine is a greater distance from the vehicle thus necessitating an increase in the length of the unloading tube.

Another aspect of unloading grain from a combine involves the use of an initial vertical section bringing the grain material to an elevation sufficiently high so that an auger unloading tube pivoted in the usual fashion can clear the height of a vehicle into which the vehicle material is unloaded. This requires extra power from the prime mover for the combine and accordingly greater consumption of fuel. Furthermore, positioning the unloader tubes in the current fashion involves taking up space in the combine that is otherwise occupied by the grain tank and thus adds to the overall envelope of the combine.

What is needed in the art therefore is an unloading tube having a high degree of flexibility and efficiency for unloading granular material.

### SUMMARY OF THE INVENTION

In one form, the invention is an unloading tube assembly having a first tube connected to and receiving material to be unloaded. A second tube is provided for discharging the material to be unloaded. An intermediate tube having swivel joints is provided between and connected to the first and second tubes, the plane of the swivel joint between the intermediate tubes and the respective first and second tubes forming an acute angle with respect to a plane perpendicular to the longitudinal axis of the tubes. The swivel joints are independently swiveled with respect to one another and a device is provided for moving material through the first tube, intermediate tube and the second tube.

In another form, the invention is a work machine such as a combine having a frame and ground drive wheels for the frame. A power unit provides power for the combine. A harvesting device is positioned in a forward location of the combine for cutting crop material and directing it to a central location. A feeder housing passes the crop material rearward. A processing apparatus receives crop material and separates grain from the crop material. A grain tank is provided for receiving grain from the separating apparatus. An unloading tube assembly has a first tube connected to and receives grain from the grain tank. A second tube is provided for discharging grain. An intermediate tube having first and second swivel joints is between and connected to the first and second tubes. The plane of the swivel joint between the intermediate tube and the respective first and second tubes forms an acute angle with respect to a plane perpendicular to the longitudinal axis of the tubes. The swivel joints are independently swiveled with respect to one another and a device is provided for moving grain through the first tube, intermediate tube and from the second tube.

### BRIEF DESCRIPTION OF THE DRAWINGS

FIG. 1 is an plan view of an agricultural work machine such as a combine embodying the present invention;

FIG. 2 is an enlarged perspective view of a portion of the combine shown in FIG. 1, illustrating an unloader tube embodying the present invention;

FIG. 3 is a side view of the unloading tube of FIG. 2 in a first position;

FIGS. 4-7 are views of the unloading tube of FIG. 2 in different positions;

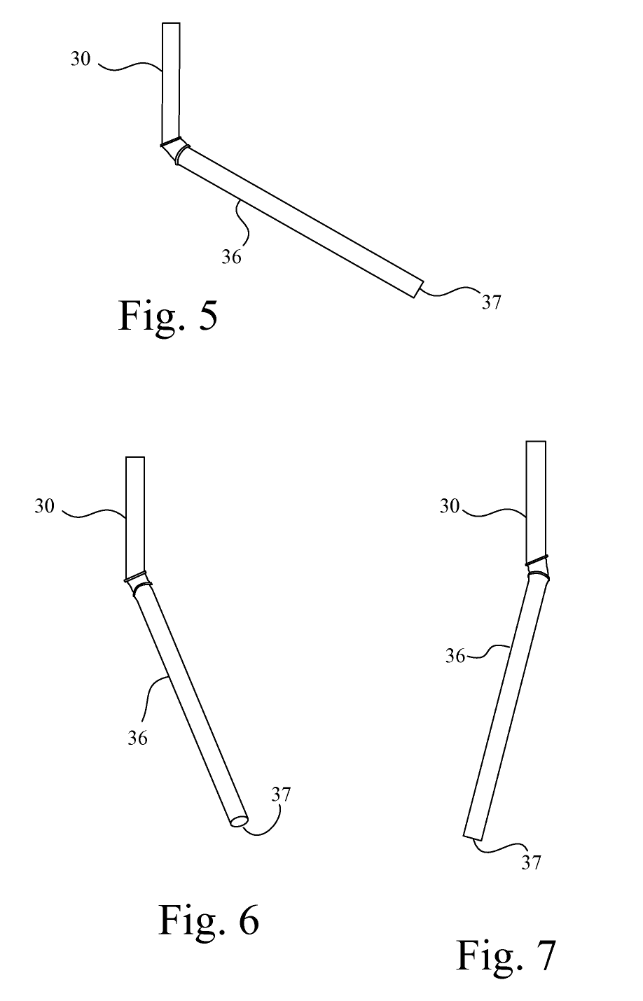

FIG. 8 shows the range of movement of the unloader tube shown in FIG. 2.

### DETAILED DESCRIPTION OF THE INVENTION

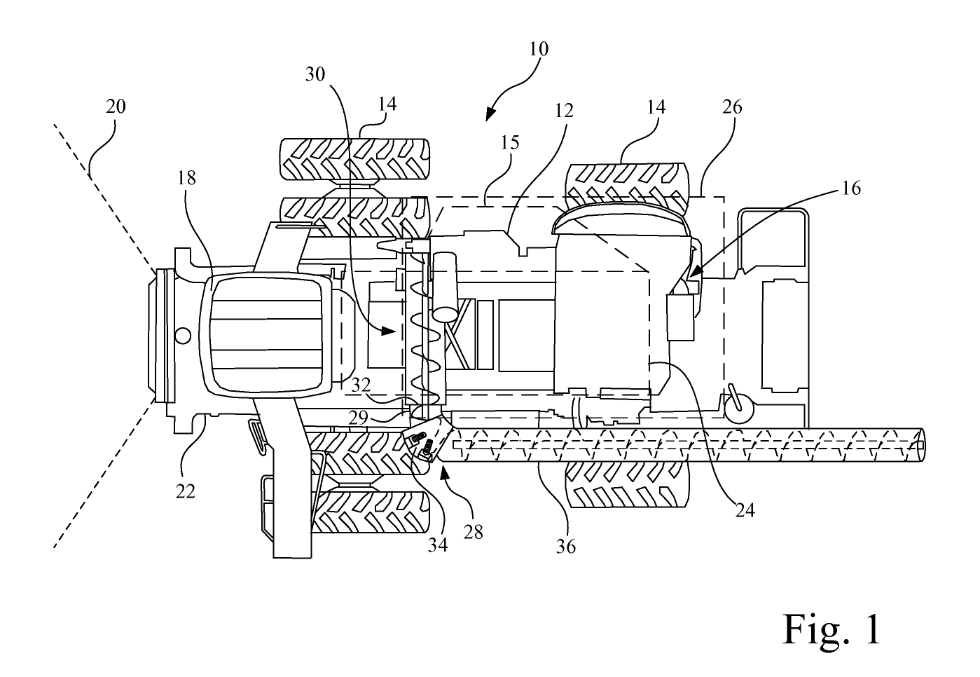

Referring to FIG. 1, there is shown an agricultural work machine such as a combine 10 having a frame 12 and driven ground wheels 14. A power unit 16 provides motive power for the combine as well as the various harvesting and processing functions. The combine 10 is controlled from an operator cab 18 located at the forward portion of the combine 10.

A harvesting device 20, shown in dashed lines, cuts and gathers crop material and directs it to a central feeder house 22 located generally beneath the operator cab 18. Processing and separating systems, indicated by dashed lines 24, remove the intended agricultural granular material from the chaff and other items to be disposed of. The granular material is deposited into a grain tank 26, also shown in schematic fashion to facilitate a better understanding of the invention. An unloading tube assembly, generally indicated by reference character 28, includes a first tube 30 extending from an inlet 32 receiving granular material from the bottom of tank 26. As shown, the first tube 30 is open across the width of the bottom of tank 26 to collect grain and move it to a transition section 29. The first tube 30 connects to an intermediate tube 34 which in turn connects to a second tube 36. The junctions between intermediate tube 34 and first tube 30 and second tube 36 are provided with swivel joints as will be described in detail.

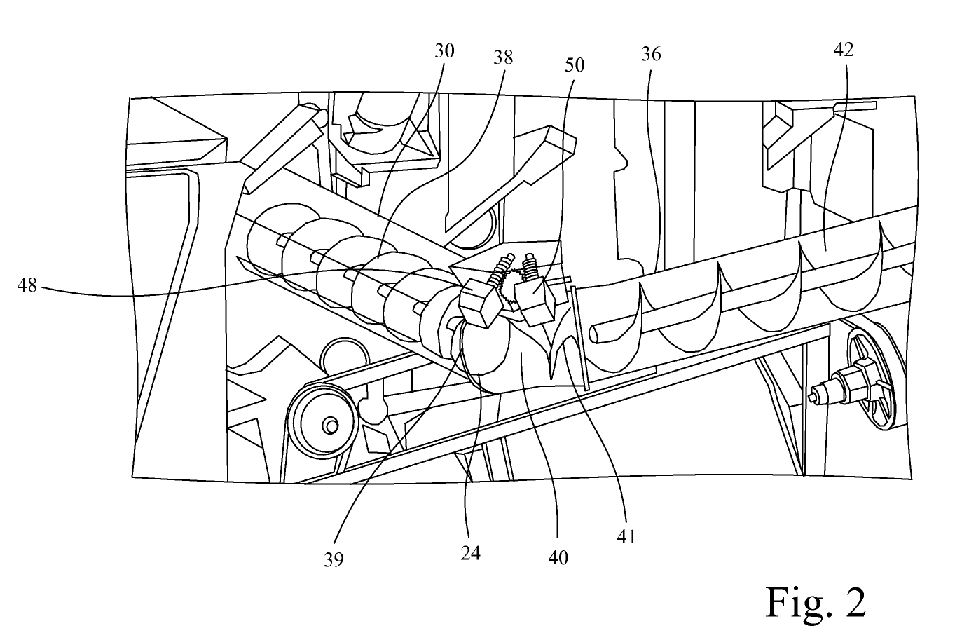

As shown particularly in FIG. 2 first tube 30 has an auger 38 driven mechanically ultimately from the power unit 16 by a mechanical connection 15, shown as a dashed line. Auger 38 connects with an intermediate auger 40 in intermediate tube 34 and then to an auger 42 in second tube 36. Auger 38, because it is open to the floor of the grain tank moves the grain to the inlet 32. It should be apparent to those skilled in the art that the tube 30 may be provided in different forms including an inlet 32 in the middle of the grain tanks 26 or even at the opposite side of the grain tank.

It should be noted that the first tube 30 is positioned approximately horizontally adjacent the floor of the grain tank 26 to utilize otherwise unused space for the unloading tube assembly and to minimize any increase of the overall envelope of the combine 10.

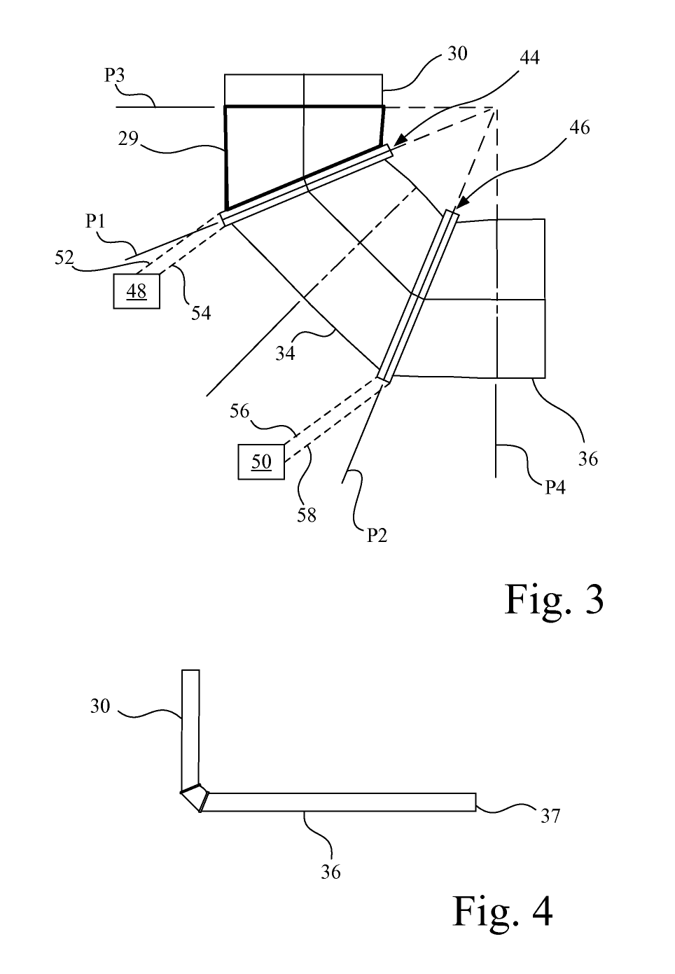

FIG. 3 shows the relationship between the tubes 30 and 36. The swivel joint 44 between first tube 30 and intermediate tube 34 is a swivel joint that allows relative rotation between tube 30 and intermediate tube 34. A second swivel joint 46 between intermediate tube 34 and second tube 36 also permits relative rotation. The mechanism for forming the joint is not shown to facilitate an understanding of the present invention. However, it should be apparent to those skilled in the art to provide such a joint. The swivel joints 44 and 46 are in planes P1 and P2 forming an acute angle with respect to planes P3 and P4 that are perpendicular to the longitudinal axis of the tubes with which they are associated. This is an angle that is greater than 0° and less than 90°. As shown in FIG. 3, angle between the planes can be approximately 22.5°.

The independent swiveling of joints 44 and 46 is accomplished by actuators 48 and 50 respectively. The actuator 48 is connected to tube 30 through connection 52 and to intermediate tube 34 through connection 54. The actuator 50 is connected to intermediate tube 34 through connection 56 and to second tube 36 by connection 58. The means to rotate the tubes relative to one another at the swivel joints may take one of a number of forms including electrical and hydraulic and pneumatic. The physical interconnection between the two may be in gear form or other as appropriate to achieve a range of swivel or articulation.

The range of movements of the swivel joints is partially illustrated by FIGS. 5-8. FIG. 5 which corresponds to the position of FIG. 3 is generally a storage position as illustrated inn FIG. 1 in which the first tube is first tube 30 as at a substantially right angle to the second tube 36. This is because the 22.5° angles of the swivel joints combine to form a right angle with respect to the first and second tubes 30 and 36, respectively. It should be noted that while the tubes 30, 34 and 36 have cylindrical cross-section, the joint, or intersection between the various tubes and the swivel joints will have a slightly oval shape. The transition section is formed so that the walls form a circular shape at the swivel joint.

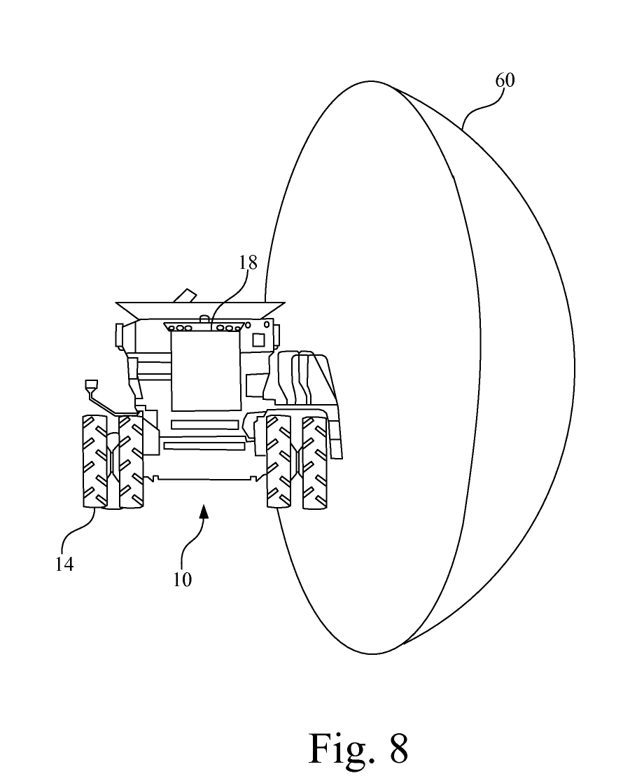

FIG. 6 shows an obtuse angle between tube 30 and tube 36. FIG. 7 shows an even greater angle between the two tubes and FIG. 8 shows an even greater angle between the tubes. The net result of the swivel joints between the tubes is shown in FIG. 9 which shows the outer range of movement of the discharge end 37 of tube 36. This range of movement is illustrated by lines 60. It can be seen that there is an order of magnitude increase in the range of movement of the unloading tubes so that a high degree of flexibility may be provided in the unloading function while at the same time enabling a compact storage of the auger when it is in the non-unloading condition. The actuators 48 and 50 for the movement of the swivel joints are conveniently located adjacent the frame 12 of the combine 10 as shown in FIG. 2 so that only a modest degree of flexibility is required to provide electrical or hydraulic power for the actuators. The augers 38, 40 and 42 are conveniently connected by either constant velocity joints or U-joints, indicated by reference characters 39 and 41 so that a single power source may be easily provided to drive the augers in unison.

Having described the preferred embodiment, it will become apparent that various modifications can be made without departing from the scope of the invention as defined in the accompanying claims.

1. An unloading tube assembly comprising:
a first tube connected to and receiving material to be unloaded;
a second tube for discharging material, an intermediate tube having first and second swivel joints between and connected to said first and second tubes, the plane of the swivel joints between the intermediate tube and the respective first and second tubes forming an acute angle with respect to a plane perpendicular to the longitudinal axis of the tubes, said swivel joints being independently swiveled with respect to one another; and,
a device for moving grain through said first tube, intermediate tube and said second tube.

2. The unloading tube as claimed in claim 1, wherein the device for moving material is an auger.

3. The unloading tube as claimed in claim 2, having an auger for each section, said augers being connected to one another by a flexible joint.

4. The unloading tube as claimed in claim 3, wherein the flexible joint is a constant velocity joint.

5. The unloading tube as claimed in claim 3, wherein the flexible joint is a U-joint connecting said augers.

6. The unloading tube as claimed in claim 1, further comprising an actuator for independently swiveling the joints with respect to one another.

7. The unloading tube as claimed in claim 6, wherein said actuator is electrically powered.

8. The unloading tube as claimed in claim 6, wherein said actuator is hydraulically powered.

9. The unloading tube as claimed in claim 1, wherein the angle is approximately 22.5 degrees.

10. A combine work machine, said combine comprising:
a frame having ground drive wheels for said frame;
a power unit for powering the combine;
a harvesting device in the forward section of said combine for harvesting crop material and directing it to a central location;
a feeder housing receiving the input from said harvesting device and passing it rearward;
a processing apparatus receiving crop material from said feeder housing for removing grain material from said crop material;
a grain tank into which the grain material is discharged; and
an unloading tube assembly for the grain tank, the unloading tube assembly comprising a first tube connected to and receiving grain from the grain tank, a second tube for discharging grain, an intermediate tube having first and second swivel joints between and connected to the first and second tubes, plane of the swivel joints between the intermediate tube and the respective first and second tubes forming acute angles with respect to planes perpendicular to the longitudinal axis of each tube, the swivel joints being independently swiveled with respect to one another and a device for moving grain through the first tube, intermediate tube and the second tube.

11. The combine as claimed in claim 10, wherein said device for moving grain is an auger assembly.

12. The combine as claimed in claim 11, wherein said augers are connected to each other through flexible joints.

13. The combine as claimed in claim 12, wherein the flexible joints are constant velocity joints.

14. The combine as claimed in claim 12, wherein the flexible joint is a U-joint.

15. The combine as claimed in claim 10, further comprising actuators for moving said swivel joints independently with respect to each other.

16. The combine as claimed in claim 16, wherein the actuator is electrically powered.

17. The combine as claimed in claim 16, wherein the actuator is hydraulically powered.

18. The combine as claimed in claim 10, wherein the angle is approximately 22.5 degrees.

19. The unloading tube as claimed in claim 1, wherein each tube has a circular cross section and a transition section to the circular swivel joint.

20. The combine as claimed in claim 10, wherein each tube has a circular cross section and a transition section to the circular swivel joint.
